(19) United States
(12) Patent Application Publication
(10) Pub. No.: US 2025/0289431 A1
(43) Pub. Date: Sep. 18, 2025

(54) VEHICLE DRIVING ASSISTANCE APPARATUS, VEHICLE DRIVING ASSISTANCE METHOD, AND STORAGE MEDIUM STORING VEHICLE DRIVING ASSISTANCE PROGRAM

(71) Applicants: TOYOTA JIDOSHA KABUSHIKI KAISHA, Aichi (JP); DENSO CORPORATION, Aichi-pref. (JP)

(72) Inventor: Hirotada OTAKE, Sunto-gun (JP)

(21) Appl. No.: 19/075,680

(22) Filed: Mar. 10, 2025

(30) Foreign Application Priority Data
Mar. 18, 2024 (JP) 2024-042325

(51) Int. Cl. B60W 30/18; B60W 30/16; B60W 60/00

(52) U.S. Cl. CPC B60W 30/18072; B60W 30/16; B60W 60/001; B60W 2554/4041; B60W 2720/10; B60W 2754/30

(57) ABSTRACT

A vehicle driving assistance apparatus selectively executes first and second movement controls as an automatic movement control. The first movement control moves the vehicle autonomously by selectively executing a powering control of powering the vehicle and a coasting control of causing the vehicle to coast to maintain a vehicle speed within a set vehicle speed range including a set vehicle speed or maintain an inter-vehicle distance between the vehicle and a preceding vehicle within a set inter-vehicle distance range including a set inter-vehicle distance. The second movement control moves the vehicle autonomously to maintain the vehicle speed at the set vehicle speed or maintain the inter-vehicle distance at the set inter-vehicle distance. The apparatus starts the first movement control when a predetermined condition that a predetermined operation is performed by an operator of the vehicle while the second movement control is being executed, becomes satisfied.

### CROSS-REFERENCE TO RELATED APPLICATIONS

This application claims priority to Japanese patent application No. JP 2024-042325 filed on Mar. 18, 2024, the content of which is hereby incorporated by reference in its entirety.

### BACKGROUND

### Field

The present invention relates to a vehicle driving assistance apparatus, a vehicle driving assistance method, and a storage medium storing a vehicle driving assistance program.

### Description of the Related Art

There is known a vehicle driving assistance apparatus that is configured to selectively execute (i) a first movement control as an automatic movement control of autonomously moving an own vehicle by selectively executing a powering control of powering the own vehicle and a coasting control of causing the own vehicle to coast to maintain an own vehicle speed (i.e., a vehicle speed of the own vehicle) within a set vehicle speed range including a set vehicle speed or maintain an inter-vehicle distance (i.e., a distance between the own vehicle and a preceding vehicle) within a set inter-vehicle distance range including a set inter-vehicle distance, and (ii) a second movement control as the automatic movement control of autonomously moving the own vehicle to maintain the own vehicle speed at the set vehicle speed or maintain the inter-vehicle distance at the set inter-vehicle distance (for example, see JP 2022-95320 A). Also, as such a vehicle driving assistance apparatus, there is known a vehicle driving assistance apparatus which is configured to interrupt the first movement control and execute the second movement control due to various circumstances related to the own vehicle (for example, see JP 2022-95320 A).

The above-mentioned vehicle driving assistance apparatus interrupts the first movement control and executes the second movement control based on a judgment of the vehicle driving assistance apparatus, but an operator of the own vehicle may not want to interrupt the first movement control. In this way, in the situation where the operator of the own vehicle does not want to interrupt the first movement control, the operator of the vehicle may want to start the first movement control while the second movement control is being executed.

### SUMMARY

An object of the present invention is to provide a vehicle driving assistance apparatus, a vehicle driving assistance method, and a storage medium storing a vehicle driving assistance program that allow the operator of the own vehicle to start the first movement control even while the second movement control is being executed.

A vehicle driving assistance apparatus according to the present invention comprises an electronic control unit which selectively executes a first movement control and a second movement control as an automatic movement control of moving an own vehicle autonomously. The first movement control is a control of moving the own vehicle autonomously by selectively executing a powering control of powering the own vehicle and a coasting control of causing the own vehicle to coast to maintain an own vehicle speed of the own vehicle within a set vehicle speed range including a set vehicle speed or maintain an inter-vehicle distance between the own vehicle and a preceding vehicle within a set inter-vehicle distance range including a set inter-vehicle distance. The second movement control is a control of moving the own vehicle autonomously to maintain the own vehicle speed at the set vehicle speed or maintain the inter-vehicle distance at the set inter-vehicle distance. The electronic control unit is configured to start the first movement control when a predetermined condition that a predetermined operation is performed by an operator of the own vehicle while the second movement control is being executed, becomes satisfied.

According to the vehicle driving assistance apparatus of the present invention, when the predetermined operation is performed by the operator of the own vehicle while the second movement control is being executed, the first movement control is started. Therefore, even while the second movement control is being executed, the operator of the vehicle can start the first movement control by performing the predetermined operation.

In the vehicle driving assistance apparatus according to an aspect of the present invention, the electronic control unit may be configured to start the first movement control by starting the coasting control when the predetermined condition becomes satisfied.

According to the vehicle driving assistance apparatus of this aspect of the present invention, when the operator of the own vehicle performs the predetermined operation, the coasting control is executed. This makes it possible to reduce an amount of energy consumed for moving the own vehicle.

In the vehicle driving assistance apparatus according to another aspect of the present invention, the electronic control unit may be configured to interrupt the first movement control and start the second movement control when an interruption condition becomes satisfied while the first movement control is being executed. The electronic control unit may be configured to, when the own vehicle speed is smaller than the set vehicle speed or the inter-vehicle distance is greater than the set inter-vehicle distance at the time when the interruption condition becomes satisfied while the first movement control is being executed, interrupt the first movement control and start the second movement control by starting powering the own vehicle to increase the own vehicle speed or decrease the inter-vehicle distance. The electronic control unit may be configured to, in the situation where the second movement control is started by starting powering the own vehicle in response to the interruption condition becoming satisfied while the first movement control is being executed, start the first movement control by starting the coasting control when the predetermined condition becomes satisfied while powering the own vehicle.

According to the vehicle driving assistance apparatus of this aspect of the present invention, when the operator of the own vehicle performs the predetermined operation while the own vehicle is being powered by the second movement control so as to increase the own vehicle speed or decrease the inter-vehicle distance after the first movement control is interrupted, the coasting control is executed. This makes it possible to reduce the amount of energy consumed for moving the own vehicle.

In the vehicle driving assistance apparatus according to further another aspect of the present invention, the electronic control unit may be configured to interrupt the first movement control when the interruption condition becomes satisfied while the first movement control is being executed, set the own vehicle speed at the time when the interruption condition becomes satisfied as the set vehicle speed, or set the inter-vehicle distance at the time when the first movement control is interrupted as the set inter-vehicle distance, and start the second movement control.

According to the vehicle driving assistance apparatus of this aspect of the present invention, when the interruption condition becomes satisfied while the first movement control is being executed, the own vehicle speed at the time when the interruption condition becomes satisfied is set to the set vehicle speed, or the inter-vehicle distance at the time when the interruption condition becomes satisfied is set to the set inter-vehicle distance, and the second movement control is started. Therefore, even while the powering control of the first movement control is being executed, the powering control can be immediately interrupted.

In the vehicle driving assistance apparatus according to further another aspect of the present invention, the electronic control unit may be configured to, when the predetermined condition becomes satisfied while the first movement control is interrupted and the second movement control is being executed, start the first movement control by starting the powering control in the situation where the powering control was being executed immediately before the first movement control was interrupted, and start the first movement control by starting the coasting control in the situation where the coasting control was being executed immediately before the first movement control was interrupted.

According to the vehicle driving assistance apparatus of this aspect of the present invention, the first movement control can be started by starting the interrupted control of the powering control or the coasting control.

In the vehicle driving assistance apparatus according to further another aspect of the present invention, in the situation where the first movement control is a control of autonomously moving the own vehicle by selectively executing the powering control and the coasting control to maintain the own vehicle speed within the set vehicle speed range, the electronic control unit may be configured to start the first movement control by starting the powering control when an own vehicle speed upper limit reaching period of time is greater than an own vehicle speed lower limit reaching period of time at the time when the predetermined condition becomes satisfied, and start the first movement control by starting the coasting control when the own vehicle speed lower limit reaching period of time is greater than the own vehicle speed upper limit reaching period of time at the time when the predetermined condition becomes satisfied. The own vehicle speed upper limit reaching period of time may be the period of time required for the own vehicle speed to reach an upper limit value of the set vehicle speed range. The own vehicle speed lower limit reaching period of time may be the period of time required for the own vehicle speed to reach a lower limit value of the set vehicle speed range. In the situation where the first movement control is a control of autonomously moving the own vehicle by selectively executing the powering control and the coasting control to maintain the inter-vehicle distance within the set inter-vehicle distance range, the electronic control unit may be configured to start the first movement control by starting the powering control when an inter-vehicle distance lower limit reaching period of time is greater than an inter-vehicle distance upper limit reaching period of time at the time when the predetermined condition becomes satisfied, and start the first movement control by starting the coasting control when the inter-vehicle distance upper limit reaching period of time is greater than the inter-vehicle distance lower limit reaching period of time at the time when the predetermined condition becomes satisfied. The inter-vehicle distance lower limit reaching period of time may be the period of time required for the inter-vehicle distance to reach a lower limit value of the set inter-vehicle distance range. The inter-vehicle distance upper limit reaching period of time may be the period of time required for the inter-vehicle distance to reach an upper limit value of the set inter-vehicle distance range.

According to the vehicle driving assistance apparatus of this aspect of the present invention, the control that has a longer execution time immediately after the start of the first movement control, of the powering control or the coasting control, is executed first. Therefore, the frequency of switching between the powering control and the coasting control can be reduced.

In the vehicle driving assistance apparatus according to further another aspect of the present invention, the predetermined operation may be an operation to increase or decrease the set vehicle speed or an operation to increase or decrease the set inter-vehicle distance. The electronic control unit may be configured to start the first movement control by starting the powering control when the predetermined condition becomes satisfied in response to the predetermined operation to increase the set vehicle speed or to decrease the set inter-vehicle distance being performed while the second movement control is being executed. The electronic control unit may be configured to start the first movement control by starting the coasting control when the predetermined condition becomes satisfied in response to the predetermined operation to decrease the set vehicle speed or to increase the set inter-vehicle distance being performed while the second movement control is being executed.

When an operation to increase the set vehicle speed is performed or an operation to decrease the set inter-vehicle distance is performed, the operator of the own vehicle wishes to increase the own vehicle speed or decrease the inter-vehicle distance. In order to increase the own vehicle speed or decrease the inter-vehicle distance, the own vehicle needs to be accelerated. According to the vehicle driving assistance apparatus of this aspect of the present invention, when the first movement control is started due to the operation to increase the set vehicle speed or decrease the set inter-vehicle distance, the powering control is executed first. On the other hand, when the operation to decrease the set vehicle speed or the operation to increase the set inter-vehicle distance is performed, the operator of the own vehicle wishes to decrease the own vehicle speed or increase the inter-vehicle distance. In order to decrease the own vehicle speed or increase the inter-vehicle distance, the own vehicle needs to be decelerated. According to the vehicle driving assistance apparatus of this aspect of the present invention, when the first movement control is started due to the operation to decrease the set vehicle speed or increase the inter-vehicle distance, the coasting control is executed first. Therefore, the control in which the operation intention of the operator of the own vehicle is reflected, can be performed at the start of the first movement control.

In the vehicle driving assistance apparatus according to further another aspect of the present invention, the electronic control unit may be configured not to start the first movement control when an interruption condition is satisfied when the predetermined condition becomes satisfied.

According to the vehicle driving assistance apparatus of this aspect of the present invention, it is possible to suppress the start of the first movement control due to the predetermined operation performed by the operator of the own vehicle when the interruption condition is satisfied.

In the vehicle driving assistance apparatus according to further another aspect of the present invention, the interruption condition may be a condition that the execution of the coasting control needs to be prohibited.

According to the vehicle driving assistance apparatus of this aspect of the present invention, it is possible to suppress the start of the first movement control due to the predetermined operation performed by the operator of the own vehicle when it is necessary to prohibit the execution of the coasting control.

In the vehicle driving assistance apparatus according to further another aspect of the present invention, the electronic control unit may be configured to interrupt the first movement control and start the second movement control when the interruption condition becomes satisfied while the first movement control is being executed. The interruption condition may include a first interruption condition that a distance between the own vehicle and a following vehicle is equal to or less than a first threshold distance, and a second interruption condition that the distance between the own vehicle and the following vehicle is equal to or less than a second threshold distance and is greater than the first threshold distance. The second threshold distance may be greater than the first threshold distance. The electronic control unit may be configured to, in the situation where the first interruption condition is satisfied, not start the first movement control even when the predetermined condition becomes satisfied while the second movement control is being executed. The electronic control unit may be configured to, in the situation where the second interruption condition is satisfied, start the first movement control when the predetermined condition becomes satisfied while the second movement control is being executed.

According to the vehicle driving assistance apparatus of this aspect of the present invention, when the distance between the vehicle and the following vehicle is relatively short, the first movement control is not executed. Therefore, it is possible to suppress the first movement control from impeding the movement of the following vehicle. On the other hand, when the distance between the vehicle and the following vehicle is relatively long, the first movement control is executed. Therefore, it is possible to execute the first movement control according to the request of the operator of the own vehicle without impeding the movement of the following vehicle.

In the vehicle driving assistance apparatus according to further another aspect of the present invention, the electronic control unit may be configured to interrupt the first movement control and start the second movement control at the time when the second interruption condition becomes satisfied in the situation where the powering control of the first movement control is being executed.

Undesirable situations are likely to occur when the powering control is continued in a situation where the condition for interrupting the first movement control is satisfied. According to the vehicle driving assistance apparatus of this aspect of the present invention, when the second interruption condition becomes satisfied while the powering control is being executed, the powering control can be immediately interrupted. This makes it possible to prevent undesirable situations from occurring.

In the vehicle driving assistance apparatus according to further another aspect of the present invention, the electronic control unit may be configured to not interrupt the first movement control even when the second interruption condition becomes satisfied in the situation where the coasting control of the first movement control is being executed, and interrupt the first movement control and start the second movement control at the time when the coasting control of the first movement control is switched to the powering control of the first movement control.

The amount of energy consumed for moving the own vehicle can be reduced by executing the coasting control of a longer period of time. According to the vehicle driving assistance apparatus of this aspect of the present invention, even when the condition for interrupting the first movement control is satisfied while the coasting control is being executed, the first movement control is not interrupted until the coasting control terminates. Therefore, the amount of energy consumed for moving the own vehicle can be reduced.

A vehicle driving assistance method according to the present invention is a method of selectively executing a first movement control and a second movement control as an automatic movement control of moving an own vehicle autonomously. The first movement control is a control of moving the own vehicle autonomously by selectively executing a powering control of powering the own vehicle and a coasting control of causing the own vehicle to coast to maintain an own vehicle speed of the own vehicle within a set vehicle speed range including a set vehicle speed or maintain an inter-vehicle distance between the own vehicle and a preceding vehicle within a set inter-vehicle distance range including a set inter-vehicle distance. The second movement control is a control of moving the own vehicle autonomously to maintain the own vehicle speed at the set vehicle speed or maintain the inter-vehicle distance at the set inter-vehicle distance. The vehicle driving assistance method comprises a step of starting the first movement control when a predetermined condition that a predetermined operation is performed by an operator of the own vehicle while the second movement control is being executed, becomes satisfied.

According to the vehicle driving assistance method of the present invention, when the predetermined operation is performed by the operator of the own vehicle while the second movement control is being executed, the first movement control is started. Therefore, even when the second movement control is being executed, the operator of the vehicle can start the first movement control by performing the predetermined operation.

A computer-readable storage medium according to the present invention stores a vehicle driving assistance program which executes a first movement control and a second movement control as an automatic movement control of moving an own vehicle autonomously. The first movement control is a control of moving the own vehicle autonomously by selectively executing a powering control of powering the own vehicle and a coasting control of causing the own vehicle to coast to maintain an own vehicle speed of the own vehicle within a set vehicle speed range including a set vehicle speed or maintain an inter-vehicle distance between the own vehicle and a preceding vehicle within a set inter-vehicle distance range including a set inter-vehicle distance. The second movement control is a control of moving the own vehicle autonomously to maintain the own vehicle speed at the set vehicle speed or maintain the inter-vehicle distance at the set inter-vehicle distance. The vehicle driving assistance program is configured to start the first movement control when a predetermined condition that a predetermined operation is performed by an operator of the own vehicle while the second movement control is being executed, becomes satisfied.

According to the vehicle driving assistance program of the present invention, when the predetermined operation is performed by the operator of the vehicle while the second movement control is being executed, the first movement control is started. Therefore, even when the second movement control is being executed, the operator of the vehicle can start the first movement control by performing the predetermined operation.

The components of the present invention are not limited to embodiments of the present invention described below with reference to the drawings. Other objects, other features, and associated advantages of the present invention will be easily understood from the description of the embodiments of the present invention.

### BRIEF DESCRIPTION OF THE DRAWINGS

FIG. 1 is a diagram showing a vehicle driving assistance apparatus according to an embodiment of the present invention.

FIG. 2 is a diagram showing a scene in which a preceding vehicle and a following vehicle are present.

FIG. 3 is a diagram showing a scene where there is no preceding vehicle or following vehicle.

FIG. 4 is a diagram showing a relationship between an engine output power and an energy efficiency of an internal combustion engine, and a relationship between a motor output power and an energy efficiency of a motor.

FIG. 5 is a flowchart showing a routine executed by the vehicle driving assistance apparatus according to the embodiment of the present invention.

FIG. 6 is a flowchart showing a routine executed by the vehicle driving assistance apparatus according to the embodiment of the present invention.

FIG. 7 is a flowchart showing a routine executed by the vehicle driving assistance apparatus according to the embodiment of the present invention.

FIG. 8 is a flowchart showing a routine executed by the vehicle driving assistance apparatus according to the embodiment of the present invention.

FIG. 9 is a flowchart showing a routine executed by the vehicle driving assistance apparatus according to a modified embodiment of the present invention.

### DETAILED DESCRIPTION

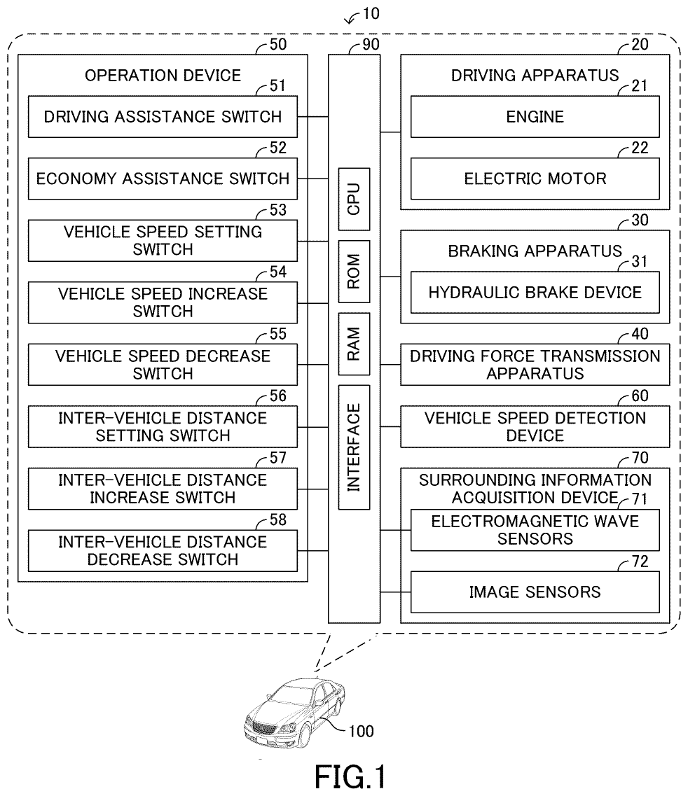

Below, a vehicle driving assistance apparatus, a vehicle driving assistance method, and a vehicle driving assistance program according to an embodiment of the present invention will be described with reference to the drawings. The vehicle driving assistance apparatus 10 is shown in FIG. 1. The vehicle driving assistance apparatus 10 is mounted on an own vehicle 100. The vehicle driving assistance apparatus 10 will be described below using as an example a case where an operator of the own vehicle 100 is a person who rides in the own vehicle 100 and drives the own vehicle 100 (i.e., a driver of the own vehicle 100).

However, the operator of the own vehicle 100 may be a person who drives the own vehicle 100 remotely without riding in the own vehicle 100 (i.e., a remote operator of the own vehicle 100). When the operator of the own vehicle 100 is the remote operator, the vehicle driving assistance apparatus 10 is mounted on the own vehicle 100 and on a remote operation facility installed outside the own vehicle 100 to remotely drive the own vehicle 100, and functions of the vehicle driving assistance apparatus 10 described below are shared between the vehicle driving assistance apparatus 10 mounted on the own vehicle 100 and the vehicle driving assistance apparatus 10 mounted on the remote operation facility.

As shown in FIG. 1, the vehicle driving assistance apparatus 10 includes an ECU (electronic control unit) 90 as a control device. The ECU 90 includes a microcomputer as a main component. The microcomputer includes a CPU, a storage medium such as a ROM, a RAM, and a non-volatile memory, and an interface. The CPU is configured to realize various functions by executing instructions, programs, or routines stored in the storage medium. In particular, in this embodiment, the vehicle driving assistance apparatus 10 stores in the storage medium programs that realizes various controls executed by the vehicle driving assistance apparatus 10.

It should be noted that the vehicle driving assistance apparatus 10 may be configured to update the programs stored in the storage medium through wireless communication (e.g., Internet communication) with an external device.

Furthermore, as shown in FIG. 1, the own vehicle 100 is equipped with a driving apparatus 20, a braking apparatus 30, and a driving force transmission apparatus 40.

The driving apparatus 20 generates a driving force to be applied to the own vehicle 100 (particularly, driven wheels of the own vehicle 100), and in this embodiment, includes an internal combustion engine 21 and at least one electric motor 22. The driving apparatus 20 is electrically connected to the ECU 90. The vehicle driving assistance apparatus 10 controls the driving force output to the own vehicle 100 by controlling an operation of the driving apparatus 20 (more specifically, an operation of the internal combustion engine 21 and an operation of the electric motor 22).

The braking apparatus 30 applies a braking force to the own vehicle 100 (particularly, wheels of the own vehicle 100), and in this embodiment, includes a hydraulic brake device 31. The braking apparatus 30 is electrically connected to the ECU 90. The vehicle driving assistance apparatus 10 controls the braking force applied to the own vehicle 100 by controlling an operation of the braking apparatus 30 (more specifically, an operation of the hydraulic brake device 31).

The driving force transmission apparatus 40 transmits the driving force output from the driving apparatus 20 to the driven wheels of the own vehicle 100, and is, for example, a transmission. The driving force transmission apparatus 40 is electrically connected to the ECU 90. The vehicle driving assistance apparatus 10 controls an operation of the driving force transmission apparatus 40 to establish a driving force transmission path (i.e., a path for transmitting the driving force from the driving apparatus 20 to the driven wheels of the own vehicle 100), and transmit the driving force output from the driving apparatus 20 to the drive wheels of the own vehicle 100, or block the driving force transmission path to prevent the driving force from being transmitted from the driving apparatus 20 to the driven wheels of the own vehicle 100.

Furthermore, the own vehicle 100 is equipped with an operation device 50, a vehicle speed detection device 60, and a surrounding information acquisition device 70.

The operation device 50 is a device into which the driver of the own vehicle 100 inputs various operations, and in this embodiment, includes a driving assistance switch 51, an economy assistance switch 52, a vehicle speed setting switch 53, a vehicle speed increase switch 54, a vehicle speed decrease switch 55, an inter-vehicle distance setting switch 56, an inter-vehicle distance increase switch 57, and an inter-vehicle distance decrease switch 58.

The driving assistance switch 51 is operated by the driver, and the driver can request the vehicle driving assistance apparatus 10 to execute an automatic movement control described below or request the vehicle driving assistance apparatus 10 to stop the automatic movement control by operating the driving assistance switch 51. The driving assistance switch 51 is electrically connected to the ECU 90. When the driver operates the driving assistance switch 51 while the automatic movement control is not executed, the vehicle driving assistance apparatus 10 determines that the execution of the automatic movement control is requested. On the other hand, when the driver operates the driving assistance switch 51 while the automatic movement control is being executed, the vehicle driving assistance apparatus 10 determines that the stop of the automatic movement control is requested.

The economy assistance switch 52 is operated by the driver, and the driver can request the execution of a first movement control described later or the stop of the first movement control by operating the economy assistance switch 52. The economy assistance switch 52 is electrically connected to the ECU 90. When the driver operates the economy assistance switch 52 while the first movement control is not executed, the vehicle driving assistance apparatus 10 determines that the execution of the first movement control is requested. On the other hand, when the driver operates the economy assistance switch 52 while the first movement control is being executed, the vehicle driving assistance apparatus 10 determines that the stop of the first movement control is requested.

The vehicle speed setting switch 53 is operated by the driver, and the driver can set a set vehicle speed Vset described later by operating the vehicle speed setting switch 53. The vehicle speed setting switch 53 is electrically connected to the ECU 90. When the vehicle speed setting switch 53 is operated (i.e., when a vehicle speed setting operation is input to the vehicle driving assistance apparatus 10), the vehicle driving assistance apparatus 10 sets the set vehicle speed Vset. The moving speed of the own vehicle 100 at that time may be set as the set vehicle speed Vset, or any vehicle speed specified by the vehicle speed setting switch 53 may be set as the set vehicle speed Vset.

The vehicle speed increase switch 54 is operated by the driver, and the driver can increase the set vehicle speed Vset by operating the vehicle speed increase switch 54. The vehicle speed increase switch 54 is electrically connected to the ECU 90. When the vehicle speed increase switch 54 is operated while the automatic movement control described later is being executed, the vehicle driving assistance apparatus 10 increases the set vehicle speed Vset. It should be noted that in this embodiment, the set vehicle speed Vset is increased by a predetermined vehicle speed ΔV each time the vehicle speed increase switch 54 is operated.

The vehicle speed decrease switch 55 is operated by the driver, and the driver can decrease the set vehicle speed Vset by operating the vehicle speed decrease switch 55. The vehicle speed decrease switch 55 is electrically connected to the ECU 90. When the vehicle speed decrease switch 55 is operated while the automatic movement control described later is being executed, the vehicle driving assistance apparatus 10 decreases the set vehicle speed Vset. It should be noted that in this embodiment, the set vehicle speed Vset is decreased by the predetermined vehicle speed ΔV each time the vehicle speed decrease switch 55 is operated.

The inter-vehicle distance setting switch 56 is operated by the driver, and the driver can set the set inter-vehicle distance DFset described later by operating the inter-vehicle distance setting switch 56. The inter-vehicle distance setting switch 56 is electrically connected to the ECU 90. When the inter-vehicle distance setting switch 56 is operated (i.e., when an inter-vehicle distance setting operation is input to the vehicle driving assistance apparatus 10), the vehicle driving assistance apparatus 10 sets the set inter-vehicle distance DFset. Any inter-vehicle distance specified by the vehicle speed setting switch 53 may be set as the set vehicle speed Vset, or a forward inter-vehicle distance DF at that time may be set as the set vehicle speed Vset.

The forward inter-vehicle distance DF is the distance between the own vehicle 100 and a preceding vehicle 200. In this embodiment, the vehicle driving assistance apparatus 10 determines whether the preceding vehicle 200 exists based on surrounding information IS described later, and when the preceding vehicle 200 exists, acquires the forward inter-vehicle distance DF based on the surrounding information IS.

The inter-vehicle distance increase switch 57 is operated by the driver, and the driver can increase the set inter-vehicle distance DFset by operating the inter-vehicle distance increase switch 57. The inter-vehicle distance increase switch 57 is electrically connected to the ECU 90. When the inter-vehicle distance increase switch 57 is operated while the automatic movement control is being executed, the vehicle driving assistance apparatus 10 increases the set inter-vehicle distance DFset. It should be noted that in this embodiment, the set inter-vehicle distance DFset is increased by a predetermined distance ΔD each time the inter-vehicle distance increase switch 57 is operated.

The inter-vehicle distance decrease switch 58 is operated by the driver, and the driver can decrease the set inter-vehicle distance DFset by operating the inter-vehicle distance decrease switch 58. The inter-vehicle distance decrease switch 58 is electrically connected to the ECU 90. When the inter-vehicle distance decrease switch 58 is operated while the automatic movement control is being executed, the vehicle driving assistance apparatus 10 decreases the set inter-vehicle distance DFset. It should be noted that in this embodiment, the set inter-vehicle distance DFset is decreased by the predetermined distance ΔD each time the inter-vehicle distance decrease switch 58 is operated.

The vehicle speed detection device 60 detects the moving speed of the own vehicle 100, and includes, for example, wheel rotation speed sensors provided on each wheel of the own vehicle 100. The vehicle speed detection device 60 is electrically connected to the ECU 90. The vehicle driving assistance apparatus 10 acquires the moving speed of the own vehicle 100 as an own vehicle speed Vego by the vehicle speed detection device 60.

The surrounding information acquisition device 70 acquires information on the surroundings of the own vehicle 100 as surrounding information IS. In this embodiment, the surrounding information acquisition device 70 includes electromagnetic wave sensors 71 such as radar sensors and image sensors 72 such as camera sensors. The electromagnetic wave sensors 71 and the image sensors 72 are electrically connected to the ECU 90. The vehicle driving assistance apparatus 10 acquires data on objects present around the own vehicle 100 (i.e., object information IO) as the surrounding information IS by the electromagnetic wave sensors 71. The vehicle driving assistance apparatus 10 also acquires image data of the front of the own vehicle 100 (i.e., image information IC) as the surrounding information IS by the image sensors 72.

### <Operation of Vehicle Driving Assistance Apparatus>

Next, an operation of the vehicle driving assistance apparatus 10 will be described. The vehicle driving assistance apparatus 10 is configured to selectively execute a first movement control and a second movement control as the automatic movement control or an automatic driving control when a predetermined condition is satisfied.

The first movement control includes a first inter-vehicle distance control and a first vehicle speed control.

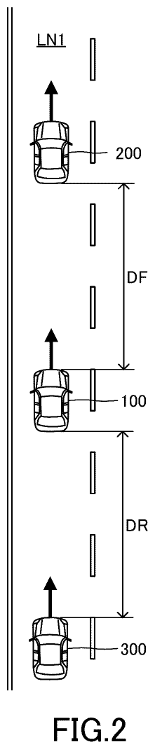

The first inter-vehicle distance control is a control of autonomously moving the own vehicle 100 by selectively executing a powering control and a coasting control to maintain the forward inter-vehicle distance DF within a set inter-vehicle distance range RDFset including the set inter-vehicle distance DFset when the preceding vehicle 200 is present as shown in FIG. 2. In other words, the first inter-vehicle distance control is a control of autonomously moving the own vehicle 100 so as to follow the preceding vehicle 200.

In this embodiment, the set inter-vehicle distance range RDFset is a range defined by a lower limit value DFlower corresponding to the set inter-vehicle distance DFset and an upper limit value DFupper corresponding to an upper inter-vehicle distance DFlimit. The upper inter-vehicle distance DFlimit is a value acquired by adding a control inter-vehicle distance width ΔDcontrol to the set inter-vehicle distance DFset. The control inter-vehicle distance width ΔDcontrol is set to a predetermined proportion Rd_preset of the set inter-vehicle distance DFset. It should be noted that the predetermined proportion Rd_preset is, for example, a value smaller than “1”, such as “0.2”. The control inter-vehicle distance width ΔDcontrol may be a constant value ΔDconstant, regardless of the set inter-vehicle distance DFset.

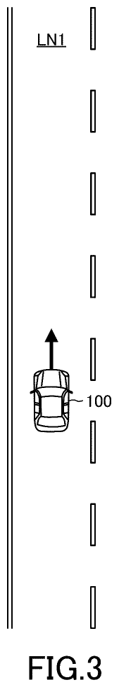

The first vehicle speed control is a control of autonomously moving the own vehicle 100 by selectively executing the powering control and the coasting control to maintain the own vehicle speed Vego within a set vehicle speed range RVset including the set vehicle speed Vset when there is no preceding vehicle 200 as shown in FIG. 3.

In this embodiment, the set vehicle speed range RVset is a range defined by an upper limit value Vupper corresponding to the set vehicle speed Vset and a lower limit value Vlower corresponding to a lower limit vehicle speed Vlimit. The lower limit vehicle speed Vlimit is a value acquired by subtracting the control vehicle speed width ΔVcontrol from the set vehicle speed Vset. The control vehicle speed range ΔVcontrol is set to a predetermined proportion Rv_preset of the set vehicle speed Vset. It should be noted that the predetermined proportion Rv_preset is, for example, a value smaller than “1”, such as “0.2”. The control vehicle speed range ΔVcontrol may be a constant value ΔVconstant regardless of the set vehicle speed Vset. In this case, the constant value ΔVconstant is a value smaller than a lower limit value of the set vehicle speed Vset that can be set.

The preceding vehicle 200 is a vehicle moving in an own vehicle moving lane LN1 in front of the own vehicle 100, and is within a predetermined forward inter-vehicle distance DFth from the own vehicle 100. In other words, the preceding vehicle 200 is a vehicle moving in the own vehicle moving lane LN1 in front of the own vehicle 100, and is a vehicle whose forward inter-vehicle distance DF is equal to or smaller than the predetermined forward inter-vehicle distance DFth. The own vehicle moving lane LN1 is the lane in which the own vehicle 100 is moving.

The powering control is control of powering the own vehicle 100. More specifically, the powering control is control of moving the own vehicle 100 while applying the driving force to the own vehicle 100. In this embodiment, when executing the powering control, the vehicle driving assistance apparatus 10 may operate the driving apparatus 20 to apply the driving force capable of accelerating the own vehicle 100 to the own vehicle 100, or may execute an optimal powering control as the powering control.

The optimal powering control is control of powering the own vehicle 100 by operating the internal combustion engine 21 at an optimal operating point where the operating efficiency of the internal combustion engine 21 that applies the driving force to the own vehicle 100 is maximized or at an operating point where the operating efficiency is substantially maximized.

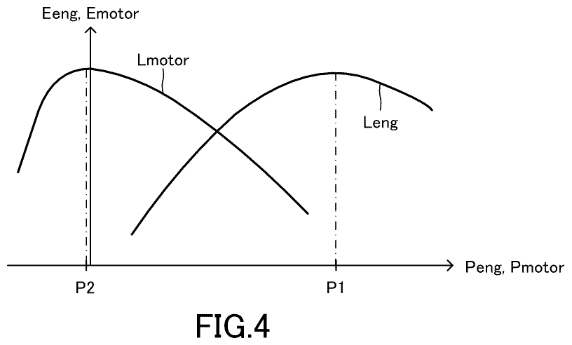

In other words, the optimal powering control is a control of applying the driving force to the own vehicle 100 while controlling the operation of the internal combustion engine 21 and the electric motor 22 such that the energy efficiency of the driving apparatus 20 is maintained at or above a predetermined efficiency. In this embodiment, the optimal powering control is a control of applying the driving force to the own vehicle 100 while controlling the operation of the internal combustion engine 21 and the electric motor 22 such that the energy efficiency of the driving apparatus 20 is maximized or substantially maximized (effectively close to the maximized efficiency). For example, in the situation where a relationship between an engine output power Peng (i.e., the driving force output from the internal combustion engine 21) and the energy efficiency Eeng of the internal combustion engine 21 is the relationship shown by the line Leng in FIG. 4, and a relationship between a motor output power Pmotor (i.e., the driving force output from the electric motor 22) and the energy efficiency Emotor of the electric motor 22 is the relationship shown by a line Lmotor in FIG. 4, the vehicle driving assistance apparatus 10 operates the internal combustion engine 21 at an optimum operating point (i.e., an operating point where the energy efficiency Eeng (or the operating efficiency) of the internal combustion engine 21 is maximum efficiency) or at an operating point where the energy efficiency Eeng is approximately maximum. It should be noted that the operating point is determined by a rotation speed (or the number of revolutions) of the internal combustion engine 21 and a load of the internal combustion engine 21.

When the internal combustion engine 21 is operated at the optimal operating point, its energy efficiency Eeng is the highest value (or the maximum efficiency), and the engine output power Peng is an optimum engine output power P1 (i.e., a value corresponding to the maximum efficiency in the example shown in FIG. 4). In FIG. 4, a reference symbol P2 is the motor output power value when the energy efficiency Emotor of the electric motor 22 is the highest.

The coasting control is a control of causing the own vehicle 100 to coast. In this embodiment, the coasting control is a control of blocking the driving force transmission path (i.e., the path for transmitting the driving force from the driving apparatus 20 to the driven wheels of the own vehicle 100) by controlling the operation of the driving force transmission apparatus 40. Therefore, according to the coasting control, the own vehicle 100 is decelerated mainly by air resistance and road resistance. It should be noted that the vehicle driving assistance apparatus 10 may stop the operation of the internal combustion engine 21 or may operate the internal combustion engine 21 in an idling state when executing the coasting control.

The second movement control includes a second vehicle distance control and a second vehicle speed control.

The second vehicle distance control is a control of autonomously moving the own vehicle 100 to maintain the forward inter-vehicle distance DF at the set inter-vehicle distance DFset.

The second vehicle speed control is a control of autonomously moving the own vehicle 100 to maintain the own vehicle speed Vego at the set vehicle speed Vset.

Furthermore, the vehicle driving assistance apparatus 10 is configured to interrupt the first movement control and execute the second movement control when a predetermined interruption condition described later becomes satisfied while the first movement control is being executed. Furthermore, the vehicle driving assistance apparatus 10 is configured to restart (or start) the first movement control when a predetermined resumption condition described later is satisfied while the second movement control is being executed after the first movement control is interrupted.

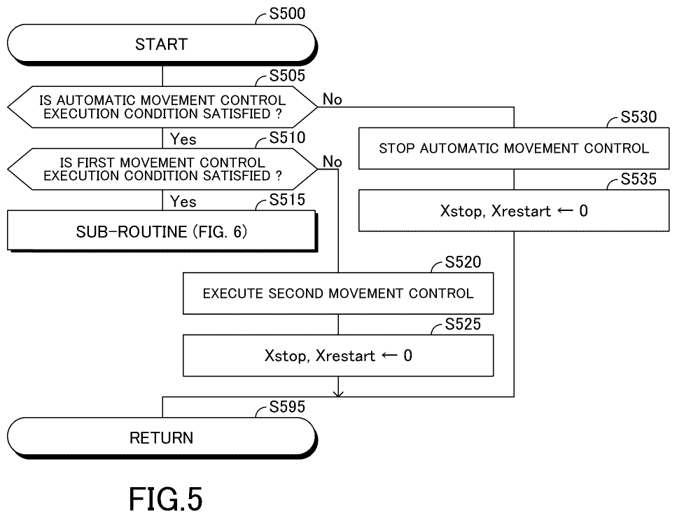

The vehicle driving assistance apparatus 10 executes routines shown in FIG. 5 to FIG. 8 to execute the first movement control or the second movement control, or interrupts the first movement control and executes the second movement control, or terminates the second movement control and restarts the first movement control, depending on the satisfied condition.

Specifically, the vehicle driving assistance apparatus 10 executes the routine shown in FIG. 5 at a predetermined time interval. Therefore, at a predetermined timing, the vehicle driving assistance apparatus 10 starts a process from a step S500 of the routine shown in FIG. 5, proceeds with the process to a step S505, and determines whether an automatic movement control execution condition Cacc is satisfied. The automatic movement control execution condition Cacc is a condition that the execution of the automatic movement control is requested.

When the automatic movement control execution condition Cacc is not satisfied, the vehicle driving assistance apparatus 10 determines “No” at the step S505, proceeds with the process to a step S530, and stops the automatic movement control in the situation where the automatic movement control is being executed. Next, the vehicle driving assistance apparatus 10 proceeds with the process to a step S535, and sets values of an interruption flag Xstop and a restart operation detection flag Xrestart to “0”. Next, the vehicle driving assistance apparatus 10 proceeds with the process to a step S595, and terminates the process of this routine once.

That is, when the execution of the automatic movement control is not requested, the automatic movement control is not executed, and when the automatic movement control is executed, the automatic movement control is stopped.

When the value of the interruption flag Xstop is “1”, the interruption flag Xstop indicates that the first movement control is in an interrupted state, and when the value of the interruption flag Xstop is “0”, the interruption flag Xstop indicates that the first movement control is not in the interrupted state.

When the value of the restart operation detection flag Xrestart is “1”, the restart operation detection flag Xrestart indicates that a restart operation is detected by the vehicle driving assistance apparatus 10, and when the value of the restart operation detection flag Xrestart is “0”, the restart operation detection flag Xrestart indicates that the restart operation is not detected by the vehicle driving assistance apparatus 10.

In this embodiment, the restart operation includes (1) a set vehicle speed decrease operation performed when the first movement control is interrupted, (2) a set vehicle speed increase operation performed when the first movement control is interrupted, (3) a set inter-vehicle distance increase operation performed when the first movement control is interrupted, and (4) a set inter-vehicle distance decrease operation performed when the first movement control is interrupted.

However, the restart operation may be one or more operations selected from (1) the set vehicle speed decrease operation performed when the first movement control is interrupted, (2) the set vehicle speed increase operation performed when the first movement control is interrupted, (3) the set inter-vehicle distance increase operation performed when the first movement control is interrupted, and (4) the set inter-vehicle distance decrease operation performed when the first movement control is interrupted.

The set vehicle speed decrease operation is an operation performed by the driver to decrease the set vehicle speed Vset (i.e., an operation performed by the driver on the vehicle speed decrease switch 55). The set vehicle speed increase operation is an operation performed by the driver to increase the set vehicle speed Vset (i.e., an operation performed by the driver on the vehicle speed increase switch 54). The set inter-vehicle distance increase operation is an operation performed by the driver to increase the set inter-vehicle distance DFset (i.e., an operation performed by the driver on the inter-vehicle distance increase switch 57). The set inter-vehicle distance decrease operation is an operation performed by the driver to decrease the set inter-vehicle distance DFset (i.e., an operation performed by the driver on the inter-vehicle distance decrease switch 58).

The vehicle driving assistance apparatus 10 detects the following operations as the restart operations: (1) when the vehicle driving assistance apparatus 10 detects an operation on the vehicle speed decrease switch 55 by the driver while the first movement control is interrupted; (2) when the vehicle driving assistance apparatus 10 detects an operation on the vehicle speed increase switch 54 by the driver while the first movement control is interrupted; (3) when the vehicle driving assistance apparatus 10 detects an operation on the inter-vehicle distance increase switch 57 by the driver while the first movement control is interrupted; and (4) when the vehicle driving assistance apparatus 10 detects an operation on the inter-vehicle distance decrease switch 58 by the driver while the first movement control is interrupted.

It should be noted that the vehicle driving assistance apparatus 10 (1) decreases the set vehicle speed Vset when the vehicle driving assistance apparatus 10 detects the set vehicle speed decrease operation as the restart operation, (2) increases the set vehicle speed Vset when the vehicle driving assistance apparatus 10 detects the set vehicle speed increase operation as the restart operation, (3) increases the set inter-vehicle distance DFset when the vehicle driving assistance apparatus 10 detects the set inter-vehicle distance increase operation as the restart operation, and (4) decreases the set inter-vehicle distance DFset when the vehicle driving assistance apparatus 10 detects the set inter-vehicle distance decrease operation as the restart operation.

However, the vehicle driving assistance apparatus 10 may be configured to (1) not decrease the set vehicle speed Vset when the vehicle driving assistance apparatus 10 detects the set vehicle speed decrease operation as the restart operation, (2) not increase the set vehicle speed Vset when the vehicle driving assistance apparatus 10 detects the set vehicle speed increase operation as the restart operation, (3) not increase the set inter-vehicle distance DFset when the vehicle driving assistance apparatus 10 detects the set inter-vehicle distance increase operation as the restart operation, or (4) not decrease the set inter-vehicle distance DFset when the vehicle driving assistance apparatus 10 detects the set inter-vehicle distance decrease operation as the restart operation.

When the automatic movement control execution condition Cacc is satisfied, the vehicle driving assistance apparatus 10 determines “Yes” at the step S505, proceeds with the process to a step S510, and determines whether a first movement control execution condition Ceco is satisfied. The first movement control execution condition Ceco is a condition that the execution of the first movement control is requested.

When the first movement control execution condition C eco is not satisfied, the vehicle driving assistance apparatus 10 determines “No” at the step S510, proceeds with the process to a step S520, and executes the second movement control. Next, the vehicle driving assistance apparatus 10 proceeds with the process to a step S525, and sets the values of the interruption flag Xstop and the restart operation detection flag Xrestart to “0”. Next, the vehicle driving assistance apparatus 10 proceeds with the process to the step S595, and terminates the process of this routine once.

That is, when the automatic movement control execution condition Cacc is satisfied but the first movement control execution condition C eco is not satisfied, the second movement control is executed.

It should be noted that, in the situation where the preceding vehicle 200 exists at the time when the vehicle driving assistance apparatus 10 proceeds with the process to the step S520, the vehicle driving assistance apparatus 10 executes the second inter-vehicle distance control as the second movement control. On the other hand, in the situation where the preceding vehicle 200 does not exist, the vehicle driving assistance apparatus 10 executes the second vehicle speed control as the second movement control.

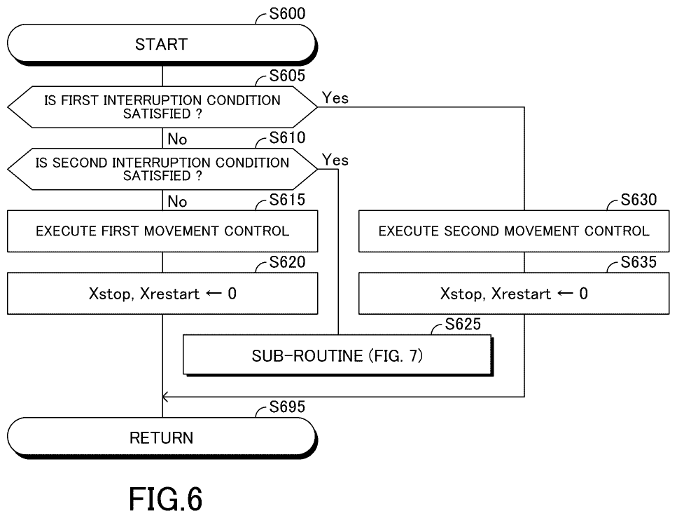

On the other hand, when the first movement control execution condition C eco is satisfied, the vehicle driving assistance apparatus 10 determines “Yes” at the step S510, proceeds with the process to a step S515, and executes the routine shown in FIG. 6. Therefore, when the vehicle driving assistance apparatus 10 proceeds with the process to the step S515, the vehicle driving assistance apparatus 10 starts the process from a step S600 of the routine shown in FIG. 6, proceeds with the process to a step S605, and determines whether a first interruption condition Cstop_1 is satisfied.

The first interruption condition Cstop_1 is a condition that it is necessary to prohibit the execution of the coasting control. For example, the first interruption condition Cstop_1 is one or more conditions selected from the following: (1) an internal combustion engine condition that it is necessary to prohibit the stop of the operation of the internal combustion engine 21; (2) a vehicle speed condition that the vehicle speed Vego is equal to or less than a predetermined threshold vehicle speed Vth (Vego≤Vth); (3) a road gradient condition that the road on which the own vehicle 100 is moving is an uphill road and the gradient θ of the uphill road is equal to or greater than a predetermined threshold gradient θth (θ>θth); and (4) a following inter-vehicle distance condition that the distance between the own vehicle 100 and the following vehicle 300 (or a rearward inter-vehicle distance DR) is equal to or less than a predetermined threshold distance (or a first threshold distance DR1) (DR≤DR1). When the first interruption condition Cstop_1 is the internal combustion engine condition, the vehicle speed condition, the road gradient condition, and the following vehicle distance condition, the first interruption condition Cstop_1 is satisfied when any one of these conditions is satisfied.

As shown in FIG. 2, the following vehicle 300 is a vehicle moving on the own vehicle moving lane LN1 behind the own vehicle 100, and is present within a predetermined rearward inter-vehicle distance DRth from the own vehicle 100. In other words, the following vehicle 300 is a vehicle moving on the own vehicle moving lane LN1 behind the own vehicle 100, and has the rearward inter-vehicle distance DR that is equal to or less than the predetermined rearward inter-vehicle distance DRth. The rearward inter-vehicle distance DR is the distance between the own vehicle 100 and the following vehicle 300. In this embodiment, the vehicle driving assistance apparatus 10 determines whether or not the following vehicle 300 exists based on the surrounding information IS, and when the following vehicle 300 exists, acquires the rearward inter-vehicle distance DR based on the surrounding information IS.

When the first interruption condition Cstop_1 is not satisfied, the vehicle driving assistance apparatus 10 determines “No” at the step S605, proceeds with the process to a step S610, and determines whether a second interruption condition Cstop_2 is satisfied.

The second interruption condition Cstop_2 is a condition that it is desirable to prohibit the execution of the coasting control. For example, the second interruption condition Cstop_2 is a condition that the distance between the own vehicle 100 and the following vehicle 300 is equal to or less than a second threshold distance DR2 that is greater than the first threshold distance DR1, but is greater than the first threshold distance DR1 (DR1<DR≤DR2).

When the second interruption condition Cstop_2 is not satisfied, the vehicle driving assistance apparatus 10 determines “No” at the step S610, proceeds with the process to a step S615, and executes the first movement control.

In other words, when the execution of the automatic movement control and the first movement control is requested and neither the first interruption condition Cstop_1 nor the second interruption condition Cstop_2 is satisfied, the first movement control is executed.

It should be noted that in the situation where the preceding vehicle 200 exists at the time when the vehicle driving assistance apparatus 10 proceeds with the process to the step S615, the vehicle driving assistance apparatus 10 executes the first inter-vehicle distance control as the first movement control. On the other hand, in the situation where the preceding vehicle 200 does not exist, the vehicle driving assistance apparatus 10 executes the first vehicle speed control as the first movement control.

Then, the vehicle driving assistance apparatus 10 proceeds with the process to a step S620, and sets the values of the interruption flag Xstop and the restart operation detection flag Xrestart to “0”. Next, the vehicle driving assistance apparatus 10 proceeds with the process to a step S695, and terminates the process of this routine once.

On the other hand, when the first interruption condition Cstop_1 is satisfied, the vehicle driving assistance apparatus 10 determines “Yes” at the step S605, proceeds with the process to a step S630, and executes the second movement control.

In other words, even in the situation where the execution of the automatic movement control and the first movement control is requested, when the first interruption condition Cstop_1 is satisfied, the first movement control is not executed, and the second movement control is executed.

Therefore, when the vehicle driving assistance apparatus 10 proceeds with the process to the step S630 for the first time after the execution of the automatic movement control and the first movement control is requested, the first interruption condition Cstop_1 is satisfied, so the vehicle driving assistance apparatus 10 does not execute the first movement control, but executes the second movement control.

Furthermore, in the situation where the vehicle driving assistance apparatus 10 is executing the first movement control at the time when the vehicle driving assistance apparatus 10 proceeds with the process to the step S630, the vehicle driving assistance apparatus 10 interrupts the first movement control and starts the second movement control.

Furthermore, in the situation where the vehicle driving assistance apparatus 10 is executing the second movement control with the first movement control interrupted at the time when the vehicle driving assistance apparatus 10 proceeds with the process to the step S630, the vehicle driving assistance apparatus 10 continues the second movement control.

Furthermore, in the situation where the vehicle driving assistance apparatus 10 is executing the second movement control with the first movement control interrupted at the time when the vehicle driving assistance apparatus 10 proceeds with the process to the step S630, the vehicle driving assistance apparatus 10 continues the second movement control even when the vehicle driving assistance apparatus 10 has detected the restart operation. Therefore, the vehicle driving assistance apparatus 10 is configured not to start the first movement control when an interruption condition (i.e., the first interruption condition Cstop_1) is satisfied at the time when a predetermined condition (i.e., the first restart condition Crestart_1 or the second restart condition Crestart_2 described later) becomes satisfied.

It should be noted that, in the situation where the preceding vehicle 200 exists at the time when the vehicle driving assistance apparatus 10 proceeds with the process to the step S630, the vehicle driving assistance apparatus 10 executes the second inter-vehicle distance control as the second movement control. On the other hand, in the situation where the preceding vehicle 200 does not exist at the time when the vehicle driving assistance apparatus 10 proceeds with the process to the step S630, the vehicle driving assistance apparatus 10 executes the second vehicle speed control as the second movement control.

Then, the vehicle driving assistance apparatus 10 proceeds with the process to a step S635, and sets the values of the interruption flag Xstop and the restart operation detection flag Xrestart to “0”. Next, the vehicle driving assistance apparatus 10 proceeds with the process to the step S695, and terminates the process of this routine once.

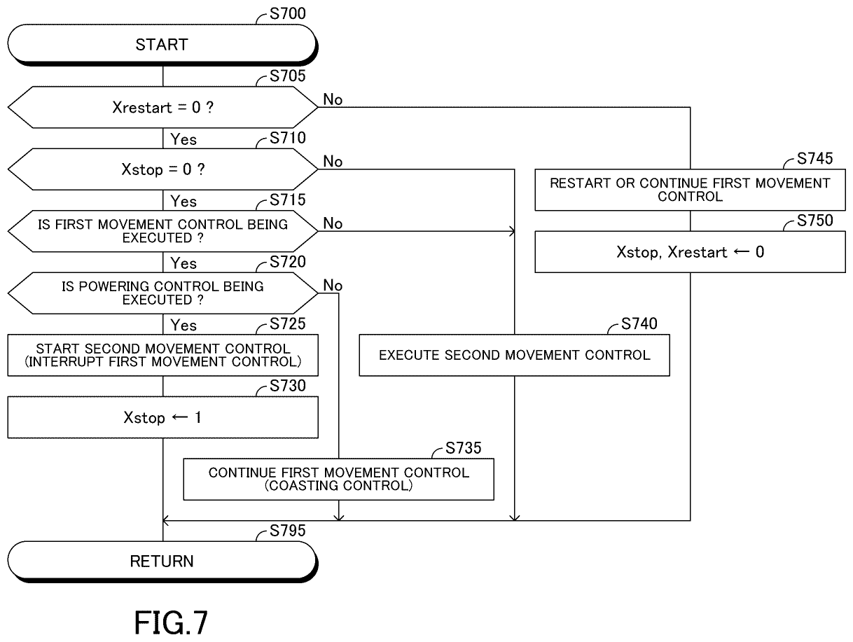

Furthermore, when the first interruption condition Cstop_1 is not satisfied but the second interruption condition Cstop_2 is satisfied, the vehicle driving assistance apparatus 10 determines “Yes” at the step S610, proceeds with the process to a step S625, and executes the routine shown in FIG. 7. Therefore, when the vehicle driving assistance apparatus 10 proceeds with the process to the step S625, the vehicle driving assistance apparatus 10 starts the process from a step S700 of the routine shown in FIG. 7, proceeds with the process to a step S705, and determines whether the value of the restart operation detection flag Xrestart is “0”. That is, the vehicle driving assistance apparatus 10 determines whether the restart operation has been detected.

When the value of the restart operation detection flag Xrestart is “0”, the vehicle driving assistance apparatus 10 determines “Yes” at the step S705, proceeds with the process to a step S710, and determines whether the value of the interruption flag Xstop is “0”. That is, the vehicle driving assistance apparatus 10 determines whether the first movement control is interrupted.

When the value of the interruption flag Xstop is “0”, the vehicle driving assistance apparatus 10 determines “Yes” at the step S710, proceeds with the process to a step S715, and determines whether the first movement control is being executed.

When the first movement control is being executed, the vehicle driving assistance apparatus 10 determines “Yes” at the step S715, proceeds with the process to a step S720, and determines whether the powering control of the first movement control is being executed.

When the powering control of the first movement control is being executed, the vehicle driving assistance apparatus 10 determines “Yes” at the step S720, proceeds with the process to a step S725, and interrupts the first movement control, and starts the second movement control.

That is, in the situation where the execution of the automatic movement control and the first movement control is requested and the first interruption condition Cstop_1 is not satisfied but the second interruption condition Cstop_2 is satisfied, when the restart operation is not detected and the first movement control is not interrupted and the powering control of the first movement control is being executed, the first movement control is immediately interrupted and the second movement control is started.

Therefore, the vehicle driving assistance apparatus 10 is configured to interrupt the first movement control and start the second movement control at the time when the second interruption condition Cstop_2 becomes satisfied in the situation where the powering control is being executed at the time when the second interruption condition Cstop_2 becomes satisfied while the first movement control is being executed.

It should be noted that, when the own vehicle speed Vego is smaller than the set vehicle speed Vset or the forward inter-vehicle distance DF is greater than the set inter-vehicle distance DFset at the time when the vehicle driving assistance apparatus 10 interrupts the first movement control and starts the second movement control, the vehicle driving assistance apparatus 10 starts the second movement control by starting the powering of the own vehicle 100.

Therefore, when the own vehicle speed Vego is smaller than the set vehicle speed Vset or the forward inter-vehicle distance DF is greater than the set inter-vehicle distance DFset at the time when the interruption condition (i.e., the first interruption condition Cstop_1 or the second interruption condition Cstop_2) becomes satisfied in the situation where the interruption condition (i.e., the first interruption condition Cstop_1 or the second interruption condition Cstop_2) becomes satisfied while the first movement control is being executed, the vehicle driving assistance apparatus 10 is configured to start the powering of the own vehicle 100 such that the own vehicle speed Vego increases or the forward inter-vehicle distance DF decreases.

Then, the vehicle driving assistance apparatus 10 proceeds with the process to a step S730 and sets the value of the interruption flag Xstop to “1”. Next, the vehicle driving assistance apparatus 10 proceeds with the process to a step S795 and terminates the process of this routine once.

On the other hand, when the powering control of the first movement control is not executed (i.e., when the coasting control of the first movement control is being executed), the vehicle driving assistance apparatus 10 determines “No” at the step S720, proceeds with the process to a step S735, and continues the first movement control (i.e., the coasting control of the first movement control). Next, the vehicle driving assistance apparatus 10 proceeds with the process to the step S795, and terminates the process of this routine once.

According to this, when there is no change in the various conditions (i.e., the first interruption condition Cstop_1, the second interruption condition Cstop_2, the automatic movement control execution condition Cacc, and the first movement control execution condition Ceco), the coasting control of the first movement control is continued, and the own vehicle speed Vego reaches the lower limit value Vlower of the set vehicle speed range RVset. At this time, the coasting control is terminated, and the powering control of the first movement control is started. At this time, since the powering control of the first movement control is being executed, the determination is “Yes” at the time when the process advances to the step S720, the process proceeds with the process to the step S725, the first movement control is interrupted, and the second movement control is started.

Therefore, when the vehicle driving assistance apparatus 10 is executing the coasting control at the time when the second interruption condition Cstop_2 becomes satisfied while the first movement control is being executed, the vehicle driving assistance apparatus 10 is configured to interrupt the first movement control and start the second movement control at the time when the coasting control is switched to the powering control without interrupting the first movement control at the time when the second interruption condition Cstop_2 becomes satisfied.

In this way, in this embodiment, when the powering control of the first movement control is being executed when the second interruption condition Cstop_2 becomes satisfied, the first movement control is immediately interrupted. On the other hand, when the coasting control of the first movement control is being executed when the second interruption condition Cstop_2 becomes satisfied, the first movement control is interrupted after the coasting control of the first movement control is terminated.

Furthermore, when the first movement control is not executed at the time when the vehicle driving assistance apparatus 10 proceeds with the process to the step S715, the vehicle driving assistance apparatus 10 determines “No” at the step S715, proceeds with the process to a step S740, and executes the second movement control. Next, the vehicle driving assistance apparatus 10 proceeds with the process to the step S795, and terminates the process of this routine once.

That is, in the situation where the execution of the automatic movement control and the first movement control is requested and the first interruption condition Cstop_1 is not satisfied but the second interruption condition Cstop_2 is satisfied, when the first movement control is not executed but the first movement control is not in the interrupted state and the restart operation is not detected, the second movement control is executed.

For example, when the automatic movement control execution condition Cacc and the first movement control execution condition Ceco become satisfied for the first time in the situation where the first interruption condition Cstop_1 is not satisfied but the second interruption condition Cstop_2 is satisfied, neither the first movement control nor the second movement control has been started at that time. Therefore, the first movement control is not in the interrupted state. Therefore, the restart operation is not detected. At this time, when the process advances to the step S740, the second movement control is started. Then, when there is no change in the conditions (i.e., the first interruption condition Cstop_1, the second interruption condition Cstop_2, the automatic movement control execution condition Cacc, and the first movement control execution condition Ceco), the process advances to the step S740, and the second movement control is continued.

Furthermore, when the value of the interruption flag Xstop is “1” at the time when the vehicle driving assistance apparatus 10 proceeds with the process to the step S710, the vehicle driving assistance apparatus 10 determines “No” at the step S710, proceeds with the process to the step S740, and executes the second movement control. Next, the vehicle driving assistance apparatus 10 proceeds with the process to the step S795 and terminates the process of this routine once.

That is, when no restart operation has been detected in the situation where the first interruption condition Cstop_1 is not satisfied but the second interruption condition Cstop_2 is satisfied and the first movement control is interrupted (i.e., the first movement control is interrupted and the second movement control is being executed), the process advances to the step S740, and the second movement control is continued.

Furthermore, when the value of the restart operation detection flag Xrestart is “1” at the time when the vehicle driving assistance apparatus 10 proceeds with the process to the step S705, the vehicle driving assistance apparatus 10 determines “No” at the step S705, proceeds with the process to a step S745, and executes the first movement control. Next, the vehicle driving assistance apparatus 10 proceeds with the process to a step S750, and sets the value of the interruption flag Xstop to “0”. Next, the vehicle driving assistance apparatus 10 proceeds with the process to the step S795, and terminates the process of this routine once.

That is, when the restart operation (i.e., the predetermined operation) is detected while the first movement control is interrupted, the first movement control is restarted. Then, if there is no change in the various conditions (i.e., the first interruption condition Cstop_1, the second interruption condition Cstop_2, the automatic movement control execution condition Cacc, and the first movement control execution condition Ceco), the process advances to the step S745, and the first movement control is continued.

In this way, the vehicle driving assistance apparatus 10 is configured to start the first movement control when the predetermined condition (i.e., the first restart condition Crestart_1 or the second restart condition Crestart_2) that the predetermined operation (i.e., the restart operation) is performed by the driver of the own vehicle 100 while the second movement control is being executed, becomes satisfied.

It should be noted that when restarting the first movement control, the vehicle driving assistance apparatus 10 executes the first movement control as follows.

That is, in the situation where the first restart condition Crestart_1 is satisfied, that is, the restart operation is detected while the own vehicle 100 is being powered to cause the vehicle speed Vego to reach the set vehicle speed V set or cause the forward inter-vehicle distance DF to reach the set inter-vehicle distance DF set after the vehicle driving assistance apparatus 10 interrupts the first movement control and starts the second movement control, when the detected restart operation is the set vehicle speed decrease operation or the set inter-vehicle distance increase operation, the vehicle driving assistance apparatus 10 restarts the first movement control by executing the coasting control.

Therefore, the vehicle driving assistance apparatus 10 is configured to interrupt the first movement control and start the second movement control by starting the powering of the own vehicle 100 such that the own vehicle speed Vego increases or the forward inter-vehicle distance DF decreases when the own vehicle speed Vego is smaller than the set vehicle speed Vset or the forward inter-vehicle distance DF is greater than the set inter-vehicle distance DFset at the time when the interruption condition (i.e., the second interruption condition Cstop_2) becomes satisfied while the first movement control is being executed. Further, in the situation where the vehicle driving assistance apparatus 10 starts the second movement control by starting the powering of the own vehicle 100 in response to the interruption condition (i.e., the second interruption condition Cstop_2) becoming satisfied while the first movement control is being executed, when the predetermined condition (i.e., the first restart condition Crestart_1) becomes satisfied while the vehicle driving assistance apparatus 10 is executing the powering of the own vehicle 100, the vehicle driving assistance apparatus 10 is configured to start the first movement control by starting the coasting control.

In short, the vehicle driving assistance apparatus 10 is configured to start the first movement control by starting the coasting control when the predetermined condition (i.e., the first restart condition Crestart_1) becomes satisfied.

Furthermore, when the detected restart operation is the set vehicle speed increase operation or the set inter-vehicle distance decrease operation at the time when the first restart condition Crestart_1 becomes satisfied, the vehicle driving assistance apparatus 10 restarts the first movement control by executing the powering control.

It should be noted that, when the detected restart operation is the set vehicle speed increase operation or the set inter-vehicle distance decrease operation at the time when the first restart condition Crestart_1 becomes satisfied, the vehicle driving assistance apparatus 10 may be configured to restart the first movement control by executing the coasting control.

That is, when the predetermined condition (i.e., the first restart condition Crestart_1) becomes satisfied, the vehicle driving assistance apparatus 10 may be configured to start the first movement control by starting the coasting control.

In addition, in the situation where the second restart condition Crestart_2 becomes satisfied, that is, the vehicle driving assistance apparatus 10 detects the restart operation while the own vehicle speed Vego is maintained at the set vehicle speed Vset or the forward inter-vehicle distance DF is maintained at the set inter-vehicle distance DFset by the second movement control after the vehicle driving assistance apparatus 10 interrupts the first movement control and starts the second movement control, when the detected restart operation is the set vehicle speed decrease operation or the set inter-vehicle distance increase operation, the vehicle driving assistance apparatus 10 restarts the first movement control by executing the coasting control.

Therefore, the vehicle driving assistance apparatus 10 is configured to start the first movement control by starting the coasting control when the predetermined condition (i.e., the second restart condition Crestart_2) becomes satisfied in response to the operation to decrease the set vehicle speed Vset or the operation to increase the set inter-vehicle distance DFset as the predetermined operation (i.e., the restart operation) while the second movement control is being executed.

In short, the vehicle driving assistance apparatus 10 is configured to start the first movement control by starting the coasting control when the predetermined condition (i.e., the second restart condition Crestart_2) becomes satisfied.

On the other hand, when the detected restart operation is the set vehicle speed increase operation or the set inter-vehicle distance decrease operation at the time when the second restart condition Crestart_2 becomes satisfied, the vehicle driving assistance apparatus 10 restarts the first movement control by executing the powering control.

Therefore, the vehicle driving assistance apparatus 10 is configured to start the first movement control by starting the powering control when the predetermined condition (i.e., the second restart condition Crestart_2) becomes satisfied in response to the operation to increase the set vehicle speed Vset or the operation to decrease the set inter-vehicle distance DFset as the predetermined operation (i.e., the restart operation) while the second movement control is being executed.

Alternatively, in the situation where the second restart condition Crestart_2 (i.e., the predetermined condition) becomes satisfied while the first movement control is in the interrupted state and the second movement control is being executed, the vehicle driving assistance apparatus 10 may be configured to start the first movement control by starting the powering control when the detected restart operation (i.e., the predetermined operation) is the set vehicle speed increase operation or the set inter-vehicle distance decrease operation and the powering control is executed immediately before the first movement control is interrupted, and to start the first movement control by starting the coasting control when the detected restart operation (i.e., the predetermined operation) is the set vehicle speed decrease operation or the set inter-vehicle distance increase operation and the coasting control is executed immediately before the first movement control is interrupted.

Alternatively, in the situation where the second restart condition Crestart_2 (i.e., the predetermined condition) becomes satisfied, the vehicle driving assistance apparatus 10 may be configured to start the first movement control by starting the powering control when the detected restart operation (i.e., the predetermined operation) is the set vehicle speed increasing operation, and an own vehicle speed upper limit reaching period of time TVupper (i.e., the period of time required for the vehicle speed Vego to reach the upper limit value Vupper of the set vehicle speed range RVset) is greater than an own vehicle speed lower limit reaching period of time TVlower (i.e., the period of time required for the vehicle speed Vego to reach the lower limit value Vlower of the set vehicle speed range RVset) at the time when the second restart condition Crestart_2 (i.e., the predetermined condition) becomes satisfied. In this case, in the situation where the second restart condition Crestart_2 (i.e., the predetermined condition) becomes satisfied, the vehicle driving assistance apparatus 10 is configured to start the first movement control by starting the coasting control when the detected restart operation (i.e., the predetermined operation) is the set vehicle speed increase operation, and the own vehicle speed lower limit reaching period of time TVlower is greater than the own vehicle speed upper limit reaching period of time TVupper at the time when the second restart condition Crestart_2 (i.e., the predetermined condition) becomes satisfied.

Similarly, in the situation where the second restart condition Crestart_2 (i.e., the predetermined condition) becomes satisfied, the vehicle driving assistance apparatus 10 may be configured to start the first movement control by starting the powering control when the detected restart operation (i.e., the predetermined operation) is the set inter-vehicle distance decrease operation, and an inter-vehicle distance lower limit reaching period of time TDFlower (i.e., the period of time required for the forward inter-vehicle distance DF to reach the lower limit value DFlower of the set inter-vehicle distance range RDFset) is greater than an inter-vehicle distance upper limit reaching period of time TDFupper (i.e., the period of time required for the forward inter-vehicle distance DF to reach the upper limit value DFupper of the set inter-vehicle distance range RDFset) at the time when the second restart condition Crestart_2 (i.e., the predetermined condition) becomes satisfied. In this case, in the situation where the second restart condition Crestart_2 (i.e., the predetermined condition) becomes satisfied, the vehicle driving assistance apparatus 10 is configured to start the first movement control by starting the coasting control when the detected restart operation (i.e., the predetermined operation) is the set inter-vehicle distance decrease operation, and the inter-vehicle distance upper limit reaching period of time TDFupper is greater than the inter-vehicle distance lower limit reaching period of time TDFlower at the time when the second restart condition Crestart_2 (i.e., the predetermined condition) becomes satisfied.

Furthermore, as can be understood from the above description, in the situation where the first interruption condition Cstop_1 is satisfied while the second movement control is being executed, even when the predetermined condition (the first restart condition Crestart_1 or the second restart condition Crestart_2) becomes satisfied, the vehicle driving assistance apparatus 10 is configured not to start the first movement control. On the other hand, in the situation where the second interruption condition Cstop_2 is satisfied while the second movement control is being executed, the vehicle driving assistance apparatus 10 is configured to start the first movement control when the predetermined condition (the first restart condition Crestart_1 or the second restart condition Crestart_2) becomes satisfied.

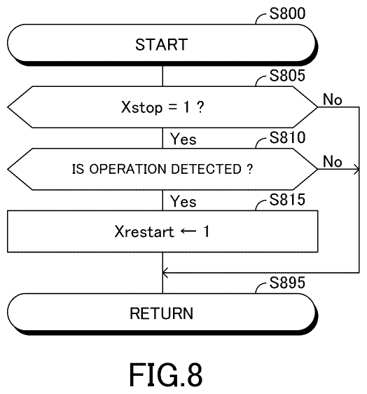

Furthermore, the vehicle driving assistance apparatus 10 is configured to execute the routine shown in FIG. 8 at predetermined time intervals. Therefore, at a predetermined timing, the vehicle driving assistance apparatus 10 starts a process from a step S800 of the routine shown in FIG. 8, proceeds with the process to a step S805, and determines whether the value of the interruption flag Xstop is “1”.

When the value of the interruption flag Xstop is “1”, the vehicle driving assistance apparatus 10 determines “Yes” at the step S805, proceeds with the process to a step S810, and determines whether or not the driver's operation on any of the vehicle speed increase switch 54, the vehicle speed decrease switch 55, the inter-vehicle distance increase switch 57, and the inter-vehicle distance decrease switch 58 is detected.

When the vehicle driving assistance apparatus 10 detects the driver's operation on any of the vehicle speed increase switch 54, the vehicle speed decrease switch 55, the inter-vehicle distance increase switch 57, and the inter-vehicle distance decrease switch 58, the vehicle driving assistance apparatus 10 determines “Yes” at the step S810, proceeds with the process to a step S815, and sets the value of the restart operation detection flag Xrestart to “1”. That is, the vehicle driving assistance apparatus 10 determines that the restart operation is detected. Next, the vehicle driving assistance apparatus 10 proceeds with the process to a step S895, and terminates the process of this routine once.

As a result, when the process advances to the step S705 of the routine shown in FIG. 7, the determination is “Yes”, the process advances to the step S745, and the first movement control is restarted.

That is, when the restart operation is detected while the first movement control is interrupted, the first movement control is restarted.

It should be noted that, when the value of the interruption flag Xstop is “0”, the vehicle driving assistance apparatus 10 determines “No” at the step S805, proceeds with the process to the step S895, and terminates the process of this routine once. That is, when the first movement control is not interrupted, the routine shown in FIG. 8 is terminated.

On the other hand, when the vehicle driving assistance apparatus 10 does not detect any operation performed by the driver on the vehicle speed increase switch 54, the vehicle speed decrease switch 55, the inter-vehicle distance increase switch 57, or the inter-vehicle distance decrease switch 58, the vehicle driving assistance apparatus 10 determines “No” at the step S810, proceeds with the process to the step S895, and terminates the process of this routine once.

The above is the operation of the vehicle driving assistance apparatus 10.

According to this, when the driver of the own vehicle 100 performs the restart operation while the second movement control is being executed, the first movement control is started. Therefore, the driver of the own vehicle 100 can start the first movement control by performing the restart operation even when the second movement control is being executed.

It should be noted that the present invention is not limited to the above embodiment, and various modified examples can be adopted within the scope of the present invention.

For example, when the first interruption condition Cstop_1 or the second interruption condition Cstop_2 becomes satisfied while the first movement control is being executed, the vehicle driving assistance apparatus 10 may be configured to reset the own vehicle speed Vego and the forward inter-vehicle distance DF at the time when the first interruption condition Cstop_1 or the second interruption condition Cstop_2 becomes satisfied as the set vehicle speed Vset and the set inter-vehicle distance DFset, respectively, and execute the second movement control to maintain the own vehicle speed Vego and the forward inter-vehicle distance DF at the newly-set set vehicle speed Vset and the set inter-vehicle distance DFset, respectively.

That is, the vehicle driving assistance apparatus 10 may be configured to interrupt the first movement control, set the own vehicle speed Vego at the time when the interruption condition (i.e., the first interruption condition Cstop_1 or the second interruption condition Cstop_2) becomes satisfied as the set vehicle speed Vset, or set the forward inter-vehicle distance DF at the time when the first movement control is interrupted as the set inter-vehicle distance DFset, and start the second movement control when the interruption condition (i.e., the first interruption condition Cstop_1 or the second interruption condition Cstop_2) becomes satisfied while the first movement control is being executed.

In this case, when a third restart condition Crestart_3 that the restart operation is detected after the vehicle driving assistance apparatus 10 interrupts the first movement control and starts the second movement control, is satisfied, the vehicle driving assistance apparatus 10 sets the original set vehicle speed Vset and the original set inter-vehicle distance DFset that were set when the first movement control was interrupted as the set vehicle speed Vset and the set inter-vehicle distance DFset, respectively. As a result, the vehicle driving assistance apparatus 10 executes the first movement control using the original set vehicle speed Vset and the original set inter-vehicle distance DFset.

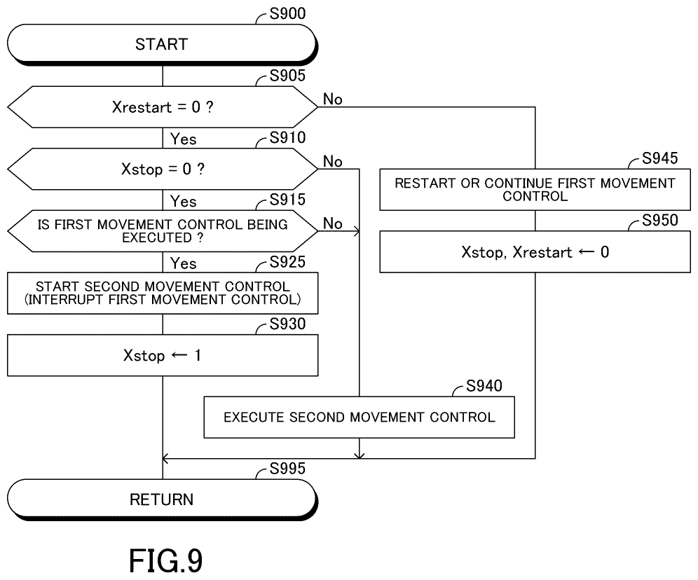

In this case, the vehicle driving assistance apparatus 10 executes a routine shown in FIG. 9 instead of the routine shown in FIG. 7. Therefore, when the vehicle driving assistance apparatus 10 proceeds with the process to the step S625 of the routine shown in FIG. 6, the vehicle driving assistance apparatus 10 starts a process from a step S900 of the routine shown in FIG. 9, proceeds with the process to a step S905, and determines whether the value of the restart operation detection flag Xrestart is “0”. That is, the vehicle driving assistance apparatus 10 determines whether the restart operation is detected.

When the value of the restart operation detection flag Xrestart is “0”, the vehicle driving assistance apparatus 10 determines “Yes” at the step S905, proceeds with the process to a step S910, and determines whether the value of the interruption flag Xstop is “0”. That is, the vehicle driving assistance apparatus 10 determines whether the first movement control is in the interrupted state.

When the value of the interruption flag Xstop is “0”, the vehicle driving assistance apparatus 10 determines “Yes” at the step S910, proceeds with the process to a step S915, and determines whether the first movement control is being executed.

When the first movement control is being executed, the vehicle driving assistance apparatus 10 determines “Yes” at the step S915, proceeds with the process to a step S925, interrupts the first movement control, and starts the second movement control.

That is, in the situation where the execution of the automatic movement control and the first movement control is requested and the first interruption condition Cstop_1 is not satisfied but the second interruption condition Cstop_2 is satisfied, when the restart operation is not detected and the first movement control is not in the interrupted state, the first movement control is immediately interrupted and the second movement control is started.

Therefore, in the situation where the second interruption condition Cstop_2 becomes satisfied while the first movement control is being executed, the vehicle driving assistance apparatus 10 is configured to interrupt the first movement control and start the second movement control at the time when the second interruption condition Cstop_2 becomes satisfied.

Then, the vehicle driving assistance apparatus 10 proceeds with the process to a step S930 and sets the value of the interruption flag Xstop to “1”. Next, the vehicle driving assistance apparatus 10 proceeds with the process to a step S995 and terminates the process of this routine once.

On the other hand, when the first movement control is not being executed at the time when the vehicle driving assistance apparatus 10 proceeds with the process to the step S915, the vehicle driving assistance apparatus 10 determines “No” at the step S915, proceeds with the process to a step S940, and executes the second movement control. Next, the vehicle driving assistance apparatus 10 proceeds with the process to the step S995, and terminates the process of this routine once.

That is, in the situation where the execution of the automatic movement control and the first movement control is requested and the first interruption condition Cstop_1 is not satisfied but the second interruption condition Cstop_2 is satisfied, when the first movement control is not executed but the first movement control is not in the interrupted state and the restart operation is not detected, the second movement control is executed.

On the other hand, when the value of the interruption flag Xstop is “1” at the time when the vehicle driving assistance apparatus 10 proceeds with the process to the step S910, the vehicle driving assistance apparatus 10 determines “No” at the step S910, proceeds with the process to a step S940, and executes the second movement control. Next, the vehicle driving assistance apparatus 10 proceeds with the process to the step S995 and terminates the process of this routine once.

That is, in the situation where the first interruption condition Cstop_1 is not satisfied but the second interruption condition Cstop_2 is satisfied and the first movement control is in the interrupted state (i.e., the first movement control is interrupted and the second movement control is being executed), when no restart operation is detected, the process advances to the step S940 and the second movement control is continued.

On the other hand, when the value of the restart operation detection flag Xrestart is “1” at the time when the vehicle driving assistance apparatus 10 proceeds with the process to the step S905, the vehicle driving assistance apparatus 10 determines “No” at the step S905, proceeds with the process to a step S945, and executes the first movement control. Next, the vehicle driving assistance apparatus 10 proceeds with the process to a step S950 and sets the value of the interruption flag Xstop to “0”. Next, the vehicle driving assistance apparatus 10 proceeds with the process to the step S995 and terminates the process of this routine once.

That is, when the restart operation is detected while the first movement control is in the interrupted state, the first movement control is restarted. Then, when there is no change in the conditions (the first interruption condition Cstop_1, the second interruption condition Cstop_2, the automatic movement control execution condition Cacc, and the first movement control execution condition Ceco), the process advances to the step S945 and the first movement control is continued.

In this way, the vehicle driving assistance apparatus 10 is configured to start the first movement control when the predetermined condition (i.e., the third restart condition Crestart_3) that the predetermined operation (i.e., the restart operation) is performed by the driver of the own vehicle 100 while the second movement control is being executed, becomes satisfied.

It should be noted that when the vehicle driving assistance apparatus 10 restarts the first movement control, the vehicle driving assistance apparatus 10 executes the first movement control as follows.

That is, in the situation where the third restart condition Crestart_3 that the restart operation is detected, is satisfied after the vehicle driving assistance apparatus 10 interrupts the first travel control and starts the second travel control, when the detected restart operation is the set vehicle speed decrease operation or the set inter-vehicle distance increase operation, the vehicle driving assistance apparatus 10 restarts the first travel control by executing the coasting control.

Therefore, the vehicle driving assistance apparatus 10 is configured to start the first travel control by starting the coasting control when the predetermined condition (i.e., the third restart condition Crestart_3) becomes satisfied in response to the operation to decrease the set vehicle speed Vset or the operation to increase the set inter-vehicle distance DFset being performed as the predetermined operation (i.e., the restart operation) while the second travel control is being executed.

In short, the vehicle driving assistance apparatus 10 is configured to start the first travel control by starting the coasting control when the predetermined condition (i.e., the third restart condition Crestart_3) becomes satisfied.

On the other hand, when the detected restart operation is the set vehicle speed increase operation or the set inter-vehicle distance decrease operation at the time when the third restart condition Crestart_3 becomes satisfied, the vehicle driving assistance apparatus 10 restarts the first movement control by executing the powering control.

Therefore, the vehicle driving assistance apparatus 10 is configured to start the first movement control by starting the powering control when the predetermined condition (i.e., the third restart condition Crestart_3) becomes satisfied in response to the operation to increase the set vehicle speed Vset or the operation to shorten the set inter-vehicle distance DFset being performed as the predetermined operation (i.e., the restart operation) while the second movement control is being executed.

Alternatively, in the situation where the third restart condition Crestart_3 (i.e., the predetermined condition) becomes satisfied when the vehicle driving assistance apparatus 10 interrupts the first movement control and executes the second movement control, the vehicle driving assistance apparatus 10 may be configured to start the first movement control by starting the powering control when the vehicle driving assistance apparatus 10 executes the powering control immediately before the vehicle driving assistance apparatus 10 interrupted the first movement control, and to start the first movement control by starting the coasting control when the vehicle driving assistance apparatus 10 executed the coasting control immediately before the vehicle driving assistance apparatus 10 interrupted the first movement control.

Alternatively, in the situation where the third restart condition Crestart_3 (i.e., the predetermined condition) becomes satisfied, the vehicle driving assistance apparatus 10 may be configured to start the first movement control by starting the powering control when the own vehicle speed upper limit reaching period of time TVupper (i.e., the period of time required for the vehicle speed Vego to reach the upper limit value Vupper of the set vehicle speed range RVset) is greater than the vehicle speed lower limit reaching period of time TVlower (the period of time required for the vehicle speed Vego to reach the lower limit value Vlower of the set vehicle speed range RVset) at the time when the third restart condition Crestart_3 (i.e., the predetermined condition) becomes satisfied. In this case, in the situation where the third restart condition Crestart_3 (i.e., the predetermined condition) becomes satisfied, the vehicle driving assistance apparatus 10 is configured to start the first movement control by starting the coasting control when the own vehicle speed lower limit reaching period of time TVlower is greater than the own vehicle speed upper limit reaching period of time TVupper at the time when the third restart condition Crestart_3 (i.e., the predetermined condition) becomes satisfied.

Similarly, in the situation where the third restart condition Crestart_3 (i.e., the predetermined condition) becomes satisfied, the vehicle driving assistance apparatus 10 may be configured to start the first movement control by starting the powering control when the inter-vehicle distance lower limit reaching period of time TDFlower (i.e., the period of time required for the forward inter-vehicle distance DF to reach the lower limit value DFlower of the set inter-vehicle distance range RDFset) is greater than the inter-vehicle distance upper limit reaching period of time TDFupper (i.e., the period of time required for the forward inter-vehicle distance DF to reach the upper limit value DFupper of the set inter-vehicle distance range RDFset) at the time when the third restart condition Crestart_3 (i.e., the predetermined condition) becomes satisfied. In this case, in the situation where the third restart condition Crestart_3 (i.e., the predetermined condition) becomes satisfied, the vehicle driving assistance apparatus 10 is configured to start the first movement control by starting the coasting control when the inter-vehicle distance upper limit reaching period of time TDFupper is greater than the inter-vehicle distance lower limit reaching period of time TDFlower at the time when the third restart condition Crestart_3 (i.e., the predetermined condition) becomes satisfied.

According to this, when the driver of the own vehicle 100 performs the restart operation while the second movement control is being executed, the first movement control is started. Therefore, the driver of the own vehicle 100 can start the first movement control by performing the restart operation even when the second movement control is being executed.

What is claimed is:

1. A vehicle driving assistance apparatus comprising an electronic control unit which selectively executes a first movement control and a second movement control as an automatic movement control of moving an own vehicle autonomously,
wherein the first movement control is a control of moving the own vehicle autonomously by selectively executing a powering control of powering the own vehicle and a coasting control of causing the own vehicle to coast to maintain an own vehicle speed of the own vehicle within a set vehicle speed range including a set vehicle speed or maintain an inter-vehicle distance between the own vehicle and a preceding vehicle within a set inter-vehicle distance range including a set inter-vehicle distance,
wherein the second movement control is a control of moving the own vehicle autonomously to maintain the own vehicle speed at the set vehicle speed or maintain the inter-vehicle distance at the set inter-vehicle distance, and
wherein the electronic control unit is configured to start the first movement control when a predetermined condition that a predetermined operation is performed by an operator of the own vehicle while the second movement control is being executed, becomes satisfied.

2. The vehicle driving assistance apparatus according to claim 1, wherein the electronic control unit is configured to start the first movement control by starting the coasting control when the predetermined condition becomes satisfied.

3. The vehicle driving assistance apparatus according to claim 1,
wherein the electronic control unit is configured to interrupt the first movement control and start the second movement control when an interruption condition becomes satisfied while the first movement control is being executed, and
wherein the electronic control unit is configured to:
when the own vehicle speed is smaller than the set vehicle speed or the inter-vehicle distance is greater than the set inter-vehicle distance at the time when the interruption condition becomes satisfied while the first movement control is being executed, interrupt the first movement control and start the second movement control by starting powering the own vehicle to increase the own vehicle speed or decrease the inter-vehicle distance; and
in the situation where the second movement control is started by starting powering the own vehicle in response to the interruption condition becoming satisfied while the first movement control is being executed, start the first movement control by starting the coasting control when the predetermined condition becomes satisfied while powering the own vehicle.

4. The vehicle driving assistance apparatus according to claim 1, wherein the electronic control unit is configured to interrupt the first movement control when the interruption condition becomes satisfied while the first movement control is being executed, set the own vehicle speed at the time when the interruption condition becomes satisfied as the set vehicle speed, or set the inter-vehicle distance at the time when the first movement control is interrupted as the set inter-vehicle distance, and start the second movement control.

5. The vehicle driving assistance apparatus according to claim 1, wherein the electronic control unit is configured to, when the predetermined condition becomes satisfied while the first movement control is interrupted and the second movement control is being executed, start the first movement control by starting the powering control in the situation where the powering control was being executed immediately before the first movement control was interrupted, and start the first movement control by starting the coasting control in the situation where the coasting control was being executed immediately before the first movement control was interrupted.

6. The vehicle driving assistance apparatus according to claim 1,
wherein in the situation where the first movement control is a control of autonomously moving the own vehicle by selectively executing the powering control and the coasting control to maintain the own vehicle speed within the set vehicle speed range, the electronic control unit is configured to:
start the first movement control by starting the powering control when an own vehicle speed upper limit reaching period of time is greater than an own vehicle speed lower limit reaching period of time at the time when the predetermined condition becomes satisfied; and
start the first movement control by starting the coasting control when the own vehicle speed lower limit reaching period of time is greater than the own vehicle speed upper limit reaching period of time at the time when the predetermined condition becomes satisfied,
the own vehicle speed upper limit reaching period of time being the period of time required for the own vehicle speed to reach an upper limit value of the set vehicle speed range, and
the own vehicle speed lower limit reaching period of time being the period of time required for the own vehicle speed to reach a lower limit value of the set vehicle speed range, and
wherein in the situation where the first movement control is a control of autonomously moving the own vehicle by selectively executing the powering control and the coasting control to maintain the inter-vehicle distance within the set inter-vehicle distance range, the electronic control unit is configured to:
start the first movement control by starting the powering control when an inter-vehicle distance lower limit reaching period of time is greater than an inter-vehicle distance upper limit reaching period of time at the time when the predetermined condition becomes satisfied; and
start the first movement control by starting the coasting control when the inter-vehicle distance upper limit reaching period of time is greater than the inter-vehicle distance lower limit reaching period of time at the time when the predetermined condition becomes satisfied,
the inter-vehicle distance lower limit reaching period of time being the period of time required for the inter-vehicle distance to reach a lower limit value of the set inter-vehicle distance range, and
the inter-vehicle distance upper limit reaching period of time being is the period of time required for the inter-vehicle distance to reach an upper limit value of the set inter-vehicle distance range.

7. The vehicle driving assistance apparatus according to claim 1,
wherein the predetermined operation is an operation to increase or decrease the set vehicle speed or an operation to increase or decrease the set inter-vehicle distance,
wherein the electronic control unit is configured to:
start the first movement control by starting the powering control when the predetermined condition becomes satisfied in response to the predetermined operation to increase the set vehicle speed or to decrease the set inter-vehicle distance being performed while the second movement control is being executed; and
start the first movement control by starting the coasting control when the predetermined condition becomes satisfied in response to the predetermined operation to decrease the set vehicle speed or to increase the set inter-vehicle distance being performed while the second movement control is being executed.

8. The vehicle driving assistance apparatus according to claim 1, wherein the electronic control unit is configured not to start the first movement control when an interruption condition is satisfied when the predetermined condition becomes satisfied.

9. The vehicle driving assistance apparatus according to claim 8, wherein the interruption condition is a condition that the execution of the coasting control needs to be prohibited.

10. The vehicle driving assistance apparatus according to claim 1,
wherein the electronic control unit is configured to interrupt the first movement control and start the second movement control when the interruption condition becomes satisfied while the first movement control is being executed,
wherein the interruption condition includes a first interruption condition that a distance between the own vehicle and a following vehicle is equal to or less than a first threshold distance, and a second interruption condition that the distance between the own vehicle and the following vehicle is equal to or less than a second threshold distance and is greater than the first threshold distance,
the second threshold distance being greater than the first threshold distance,
wherein the electronic control unit is configured to:
in the situation where the first interruption condition is satisfied, not start the first movement control even when the predetermined condition becomes satisfied while the second movement control is being executed; and
in the situation where the second interruption condition is satisfied, start the first movement control when the predetermined condition becomes satisfied while the second movement control is being executed.

11. The vehicle driving assistance apparatus according to claim 10, wherein the electronic control unit is configured to interrupt the first movement control and start the second movement control at the time when the second interruption condition becomes satisfied in the situation where the powering control of the first movement control is being executed.

12. The vehicle driving assistance apparatus according to claim 11, wherein the electronic control unit is configured to:
not interrupt the first movement control even when the second interruption condition becomes satisfied in the situation where the coasting control of the first movement control is being executed; and
interrupt the first movement control and start the second movement control at the time when the coasting control of the first movement control is switched to the powering control of the first movement control.

13. A vehicle driving assistance method of selectively executing a first movement control and a second movement control as an automatic movement control of moving an own vehicle autonomously,
wherein the first movement control is a control of moving the own vehicle autonomously by selectively executing a powering control of powering the own vehicle and a coasting control of causing the own vehicle to coast to maintain an own vehicle speed of the own vehicle within a set vehicle speed range including a set vehicle speed or maintain an inter-vehicle distance between the own vehicle and a preceding vehicle within a set inter-vehicle distance range including a set inter-vehicle distance,
wherein the second movement control is a control of moving the own vehicle autonomously to maintain the own vehicle speed at the set vehicle speed or maintain the inter-vehicle distance at the set inter-vehicle distance, and
wherein the vehicle driving assistance method comprises a step of starting the first movement control when a predetermined condition that a predetermined operation is performed by an operator of the own vehicle while the second movement control is being executed, becomes satisfied.

14. A computer-readable storage medium storing a vehicle driving assistance program which executes a first movement control and a second movement control as an automatic movement control of moving an own vehicle autonomously,
wherein the first movement control is a control of moving the own vehicle autonomously by selectively executing a powering control of powering the own vehicle and a coasting control of causing the own vehicle to coast to maintain an own vehicle speed of the own vehicle within a set vehicle speed range including a set vehicle speed or maintain an inter-vehicle distance between the own vehicle and a preceding vehicle within a set inter-vehicle distance range including a set inter-vehicle distance,
wherein the second movement control is a control of moving the own vehicle autonomously to maintain the own vehicle speed at the set vehicle speed or maintain the inter-vehicle distance at the set inter-vehicle distance, and
wherein the vehicle driving assistance program is configured to start the first movement control when a predetermined condition that a predetermined operation is performed by an operator of the own vehicle while the second movement control is being executed, becomes satisfied.
